(19) United States
(12) Patent Application Publication
(10) Pub. No.: US 2003/0099357 A1
(43) Pub. Date: May 29, 2003

(54) Apparatus and method for generating scrambling code in a CDMA mobile communication system

(76) Inventors: Dong-Ryeol Ryu, Seoul (KR); Joo-Kwang Kim, Yongin-shi (KR); Kwang-Man Ok, Songnam-shi (KR); Chae-Man Lim, Seoul (KR); Seong-Ho Hur, Songnam-shi (KR)

Correspondence Address: McGuire Woods LLP, Suite 1800, 1750 Tysons Boulevard, McLean, VA, 22102, US

(21) Appl. No.: 10/265,147

(22) Filed: Oct. 7, 2002

(30) Foreign Application Priority Data
Oct. 6, 2001 (KR) 61693/2001

(51) Int. Cl. H04K 1/02

(52) U.S. Cl. 380/252; 380/270

(57) ABSTRACT

An apparatus and method for generating cell-specific scrambling codes in an asynchronous CDMA mobile communication system. A predetermined number of base scrambling codes are stored as initial conditions. An intended scrambling code is generated by cyclically shifting or masking a corresponding base scrambling code. This provides for generating cell-specific scrambling codes at any point in time to achieve high-speed cell search.

### BACKGROUND OF THE INVENTION

1. Field of the Invention

The present invention relates generally to an apparatus and method for generating scrambling codes in a CDMA (Code Division Multiple Access) mobile communication system, and in particular, to an apparatus and method for generating scrambling codes by cyclic shifting or masking during an initialization process.

2. Description of the Related Art

In general, a different downlink scrambling code is assigned to each Node B so that UEs (User Equipment) can identify it in a CDMA mobile communication system. Although a total of 262,143 (2¹⁸−1) scrambling codes numbered from 0 to 262,142 can be used, all of them are not used. 8,192 scrambling codes are grouped into 512 code sets, each code set containing one primary scrambling code and 15 secondary scrambling codes.

The primary scrambling code of an i^{th} code set is expressed as “16×i” (i=0, 1, . . . , 511) and a secondary scrambling code in the i^{th} code set is expressed as “16×i+k” (k=0, 1, . . . , 15). Thus 15 secondary scrambling codes are mapped to one primary scrambling code in each code set.

The 512 code sets are further divided into 64 groups, each group containing 8 primary scrambling codes. The scrambling codes in an i^{th} scrambling code group are expressed as 16×8×i+16×j+k, where i=0, 1, . . . , 63, j=0, 1, . . . , 7, and k=0, 1, . . . , 15. Each cell is assigned one primary scrambling code.

As described above, 8192 scrambling codes (k=0, 1, . . . , 8,191) are available. Besides these scrambling codes, alternative scrambling codes can be used in a compressed mode. Left and right alternative scrambling codes for a scrambling code k are k+8,192 and k+16,384, respectively.

A scrambling sequence, repeated per 10-ms radio frame, is a complex sequence constructed by combining two real sequences. The two real sequences are constructed from position wise modulo 2 sum of 38400 chip segments of two binary m-sequences generated by means of two generator polynomials of degree 18. Let x and y be the two m-sequences respectively. The x sequence is constructed using the primitive polynomial 1+X⁷+X¹⁸ and the y sequence is constructed using the primitive polynomial 1+X⁵+X⁷+X¹⁰+X¹⁸. The resulting sequences thus constitute segments of a set of Gold sequences.

The m-sequences x and y are constructed as:

Initial conditions:

x(0)=1, x(1), . . . x(7)=0

y(0), . . . , y(17)=1 (1)

Recursive definition of subsequent symbols:

x(i+18)=x(i+17)+x(i)modulo2, i=0, 1, . . . , 2¹⁸−20

y(i+18)=y(i+10)+y(i+7)+y(i+5)+y(i)modulo2, i=0, . . . , 2¹⁸−20 (2)

Define a binary Gold sequence Zₙ by:

zₙ(i)=x((i+n)modulo 2¹⁸−1)+y(i)modulo 2, i=0, . . . , 2¹⁸−2 (3)

The real valued Gold sequence Zₙ is defined by:

$${Z}_{n} ( i ) = \{ \begin{matrix}+ 1 if {z}_{n} ( i ) = 0 \\ - 1 if {z}_{n} ( i ) = 1\end{matrix} for i = 0 , 1 , … , {2}^{18} - 2 \qquad ( 4 )$$

Now, the n^{th} complex scrambling sequence S_{DN,n} is defined as follows:

S_{DN,n}=Zₙ(i)+j_{Zn}((i+131072)modulo(2¹⁸−1)), i=0,1, . . . , 38399 (5)

The first term of Eq. (5) is a scrambling sequence for an I channel and the second term is a scrambling sequence for a Q channel. As noted from Eq. (5), scrambling codes are cyclic in a pattern of phase 0 to phase 38399.

FIG. 1 illustrates the structure of a scrambling code generator for generating a downlink scrambling code in the above-described manner in a conventional CDMA mobile communication system. Referring to FIG. 1, the scrambling code generator includes an x sequence generator and a y sequence generator. Each of the x and y sequences contain parts for generating an I channel scrambling sequence and a Q channel scrambling sequence.

Typical scrambling code initialization methods are cyclic-shifting the x sequence, storing all initial conditions, and masking.

FIG. 2 is a block diagram of a downlink scrambling code generating apparatus using cyclic shifting in the conventional CDMA mobile communication system. A scrambling code generator 214 in the conventional scrambling code generating apparatus is identical to the scrambling code generator illustrated in FIG. 1 in terms of operation and structure.

Referring to FIG. 2, upon request for initialization of the scrambling code generator 214, a controller 210 determines a scrambling code to be generated and provides overall control in relation to generation of the scrambling code. A storage 212 stores the initial conditions of a scrambling code 0 SC_{—}0. After a specific number of cyclic shifts are completed in the scrambling code generator 214, the storage 212 stores the states of x sequence delays received from the scrambling code generator 214, for use as initial conditions in the case of re-initialization. The scrambling code generator 214 generates the determined scrambling code using the initial conditions and x sequence cyclic shifts. At a re-initialization at the next frame boundary, the scrambling code generator 214 generates the scrambling code using the initial conditions stored in the storage 212 without x sequence cyclic shifts. The scrambling sequences generated in the scrambling code generator 214 are fed to a first multiplier 216 and a second multiplier 218, respectively for generating I-channel and Q-channel scrambling sequences and the I-channel and Q-channel scrambling sequences are used for data spreading or despreading.

To generate a scrambling code n SC_N, appropriate initial conditions for an x sequence and a y sequence must be set. The initial y sequence condition is always the same irrespective of scrambling codes. The initial x sequence condition is n offsets from the initial x sequence condition of the scrambling code SC₀. Therefore, after loading the initial x sequence condition of the scrambling code SC₀ from the storage 212 under the control of the controller 210, the scrambling code generator 214 cyclically shifts the initial x sequence condition n times. Assuming the initial x sequence condition for the scrambling code SC₀ is ‘000000000000000001’ from the MSB (Most Significant Bit), the initial x sequence condition for the scrambling code n SC_n is achieved by shifting ‘000000000000000001’ n times. The resulting bits are set in the delays illustrated in FIG. 1.

With asynchronous deployment in CDMA in asynchronous CDMA, code synchronization must precede demodulation in a UE, particularly at high speed to ensure communication quality code synchronization must be executed speedily. However, the n-time cyclic shifting of the x sequence for initialization of the scrambling code generator to generate the scrambling code SC_N leads to time consumption and eventually decreases communication quality.

This problem becomes apparent in FIG. 8. Referring to FIG. 8, initialization of a scrambling code for a specific cell occurs at the frame boundary of the cell. In CDMA, a UE monitors its covering cell and neighbor cells continuously. In a synchronous CDMA mobile communication system, the scrambling code is generated simply by setting the code phase of the cell through masking while maintaining the state of the scrambling code generatoL However, in asynchronous CDMA, the UE must initialize the scrambling code generator at the frame boundary of the cell, slowing the cell search speed.

FIG. 3 is a block diagram of a downlink scrambling code generating apparatus using pre-stored initial conditions in the conventional CDMA mobile communication system. A scrambling code generator 314 is identical to the scrambling code generator illustrated in FIG. 1 in terms of operation and structure.

Referring to FIG. 3, upon request for initialization of the scrambling code generator 314, a controller 310 determines a scrambling code to be generated and provides overall control in relation to generation of the scrambling code. A storage 312 stores the initial conditions of the scrambling code. The scrambling code generator 314 generates the determined scrambling code using the initial conditions. The scrambling sequences generated in the scrambling code generator 314 are fed to a first multiplier 316 and a second multiplier 318, respectively for generating I-channel and Q-channel and the I-channel and Q-channel are used for data spreading or despreading.

Storing the initial conditions of scrambling codes for initialization of a scrambling code generator reduces initialization time, relative to cyclic-shifting of an x sequence. Despite this advantage, a large memory capacity is required to store the initial conditions of all scrambling codes.

A third approach to generation of a downlink scrambling code is masking, as stated before.

FIGS. 4 and 5 respectively illustrate an x sequence generator and a y sequence generator to generate a downlink scrambling code for better understanding of masking.

An i-time cyclic-shifted m-sequence of degree 18, xⁱ is expressed as

$$\begin{matrix}{x}^{i} = {\sum }_{k = 0}^{17} {m}_{k} {x}^{k} = [ {m}_{17} {m}_{16 } … {m}_{0} ] [ \begin{matrix}{x}^{17} \\ {x}^{16} \\ ⋮ \\ {x}^{0}\end{matrix} ] for i \geq 18 & ( 6 ) \\ {x}^{i} = {\sum }_{k = 0}^{17} {m}_{k} {x}^{k} = [ {m}_{17} {m}_{16 } … {m}_{j} … {m}_{0} ] [ \begin{matrix}{x}^{17} \\ {x}^{16} \\ ⋮ \\ {x}^{0}\end{matrix} ] \\ for i \geq 18 , where \{ \begin{matrix}{m}_{j} = 1 if i = j \\ {m}_{j} = 0 if i \neq j\end{matrix} & ( 7 )\end{matrix}$$

In Eq. (6) and Eq. (7), the row vectors [m₀ m₁ . . . m₁₇] are defined as a mask for an m-sequence generator.

Referring to FIG. 4, a mask with which to generate a zero-time cyclic-shifted x sequence x⁰ with offset 0 is [0 0 0 0 0 0 0 0 0 0 0 0 0 0 0 0 0 1] and a mask with which to generate one-time cyclic-shifted x sequence x with offset 1 is [0 0 0 0 0 0 0 0 0 0 0 0 0 0 0 0 1 0] from Eq. (7), for generating 1-channel scrambling sequences. For the primitive polynomial x¹⁸=x⁷+1, a mask for generating an 18-time cyclic-shifted x sequence, x¹⁸ is [0 0 0 0 0 0 0 0 0 0 1 0 0 0 0 0 0 1] from Eq. (6).

Referring to FIG. 5, a mask with which to generate a zero-time cyclic-shifted y sequence y⁰ with offset 0 is [0 0 0 0 0 0 0 0 0 0 0 0 0 0 0 0 0 1] and a mask with which to generate one-time cyclic-shifted y sequence y¹ with offset 1 is [0 0 0 0 0 0 0 0 0 0 0 0 0 0 0 0 1 0] from Eq. (7), for generating I-channel scrambling sequences. For the primitive polynomial y¹⁸=y¹⁰+y⁷+y⁵+1, a mask for generating an 18-time cyclic-shifted y sequence, y¹⁸ is [0 0 0 0 0 0 0 1 0 0 1 0 1 0 0 0 0 1].

FIG. 6 illustrates the structure of a scrambling code generator for generating a downlink crambling code by masking in the conventional CDMA mobile communication system. Referring to FIG. 6, there are an x sequence mask and a y sequence mask for generating an I-channel scrambling sequence and an x sequence mask and a y sequence mask for generating a Q-channel scrambling sequence. Only an x sequence generator is related with scrambling code generator initialization.

As noted from Eq. (5), a Q-channel scrambling code sequence is a 131072-chip shifted version of an I-channel scrambling code sequence. Hence, given offset k or k cyclic shifts, an x sequence and a y sequence for generating an I-channel scrambling sequence are x^{k} and y^{k} and an x sequence and a y sequence for generating a Q-channel scrambling sequence are x^{k+}31072 and y^{k+131072}.

For example, an x sequence with offset 0 for generating a Q-channel scrambling sequence is x¹³¹⁰⁷² (=x¹⁵+x⁶+x⁴) and a mask for the x sequence is [001000000001010000]. A y sequence with offset 0 for generating the Q-channel scrambling sequence is y¹³¹⁰⁷² (=y¹⁵+y¹⁴+y¹³y¹²+y¹¹+y¹⁰+y⁹+y⁸+y⁶+y⁵) and a mask for the y sequence is [001111111101100000].

When x-sequence and y-sequence masks with offset 0 are used, the scrambling code generator illustrated in FIG. 6 is equivalent to the scrambling code generator illustrated in FIG. 1.

FIG. 7 is a block diagram of a downlink scrambling code generating apparatus using asking in the conventional CDMA mobile communication system. The scrambling code enerator illustrated in FIG. 6 is used for the scrambling code generating apparatus.

Referring to FIG. 7, a controller 710 determines a scrambling code to be generated upon equest for initialization of the scrambling code generator 714 and provides overall control to generate the scrambling code. A storage 712 stores the initial conditions of the scrambling code SCO and masks for the determined scrambling code. The scrambling code generator 714 generates the determined scrambling code through initialization using the initial conditions and the masks. The scrambling sequences of the scrambling code are fed to a first multiplier 716 and a second multiplier 718, respectively for generating I-channel and Q-channel scrambling sequences and the I-channel and Q-channel scrambling sequences are used for data spreading and despreading.

Specifically, the scrambling code generator 714 generates the scrambling code using x sequence masks with offset k at an x sequence generator and the initial conditions of the scrambling code SC_N under the control of the controller 710. The y sequence masks applied to a y sequence generator always have offset 0.

The application of x sequence masks to the x sequence generator during the initialization process obviates the need for x sequence cyclic shifts, thereby reducing initialization time. However, use of masking for generation of all scrambling codes requires storing masks for each scrambling codes.

As described above, the cyclic shift-based scrambling code generating method extends initialization time and decreases the speed of periodic cell search, which degrades the demodulation performance of a receiver. These problems are solved by using the pre-stored initial conditions of scrambling codes. Yet, it increases memory size to store the initial conditions or masks of all scrambling codes. A scrambling code generator is initialized at a frame boundary of a specific cell, which decreases the speed of a search for a covering cell and neighbor cells.

### SUMMARY OF THE INVENTION

It is, therefore, an object of the present invention to provide a method of efficiently reducing memory size required to store the initial conditions of scrambling codes.

It is another object of the present invention to provide a method of generating a scrambling code by masking at any time point including a frame boundary to achieve high-speed cell search.

It is a further object of the present invention to provide an apparatus and method for effectively generating cell-specific scrambling codes in an asynchronous CDMA mobile communication system.

To achieve the above and other objects, there are provided an apparatus and method for generating scrambling codes in a CDMA mobile communication system. According to one aspect of the present invention, a predetermined number of base scrambling codes having indexes being K multiples (K is a constant) and masks with offsets below K are stored as initial conditions. To generate an intended scrambling code, a base scrambling code having the highest index substantially equal to or lower than the index of the intended scrambling code and a mask having an offset corresponding to the difference between the indexes of the base scrambling code and the intended scrambling code are loaded. Then the intended scrambling code is generated by masking the base scrambling code with the loaded mask.

According to another aspect of the present invention, a predetermined number of base scrambling codes having indexes being K multiples (K is a constant) are stored as initial conditions. To generate an intended scrambling code, a base scrambling code having the highest index substantially equal to or lower than the index of the intended scrambling code is loaded. The intended scrambling code is generated by cyclically shifting the base scrambling code as many times as the difference between the indexes of the base scrambling code and the intended scrambling code.

According to a further aspect of the present invention, first M successive base scrambling codes and masks with offsets being M multiples are stored as initial conditions. To generate an intended scrambling code, a base scrambling code having an index being the modulo M of the index of the intended scrambling code and a mask having the highest offset substantially equal to or lower than the index of the intended scrambling code are loaded. Then the intended scrambling code is generated by masking the base scrambling code with the loaded mask.

According to still another aspect of the present invention, L base scrambling codes having indexes being N multiples (N is a constant) to a scrambling code number M (constant) and masks with offsets being M multiples (M=N×L) are stored as initial conditions. To generate an intended scrambling code, a base scrambling code having an index being the modulo M of the index of the intended scrambling code is loaded and cyclically shifted as many times as required to generated the intended scrambling code. A mask having the highest offset equal to or lower than the index of the intended scrambling code is loaded. Then the intended scrambling code is generated by masking the shifted base scrambling code with the loaded mask.

### BRIEF DESCRIPTION OF THE DRAWINGS

The above and other objects, features and advantages of the present invention will become more apparent from the following detailed description when taken in conjunction with the accompanying drawings,

FIG. 1 illustrates the structure of a scrambling code generator in a conventional CDMA mobile communication system.

FIG. 2 is a block diagram of a cyclic shifting-based scrambling code generating apparatus in the conventional CDMA mobile communication system.

FIG. 3 is a block diagram of a scrambling code generating apparatus using pre-stored initial conditions in the conventional CDMA mobile communication system.

FIG. 4 illustrates an x-sequence generator using masking in the conventional CDMA mobile communication system.

FIG. 5 illustrates a y-sequence generator using masking in the conventional CDMA mobile communication system.

FIG. 6 illustrates a masking-based scrambling code generator in the conventional CDMA mobile communication system.

FIG. 7 is a block diagram of a masking-based scrambling code generating apparatus in the conventional CDMA mobile communication system.

FIG. 8 illustrates a frame boundary at which initialization is carried out to generate a scrambling code in the conventional CDMA mobile communication system.

FIG. 9 is a block diagram of a scrambling code generating apparatus in a CDMA mobile communication system according to the present invention. FIG. 10 is a flowchart illustrating an embodiment of scrambling code generation according to the present invention.

FIG. 11 is a flowchart illustrating another embodiment of scrambling code generation according to the present invention.

FIG. 12 is a flowchart illustrating a third embodiment of scrambling code generation according to the present invention.

FIG. 13 is a flowchart illustrating a fourth embodiment of scrambling code generation according to the present invention.

FIG. 14 illustrates masking in the CDMA mobile communication system according to the present invention.

FIG. 15 illustrates generation of a scrambling code at a time point other than a frame boundary using masking according to the first embodiment of the present invention.

FIG. 16 illustrates generation of a scrambling code at a time point other than a frame boundary using masking according to the second embodiment of the present invention.

FIG. 17 illustrates generation of a scrambling code at a time point other than a frame boundary using masking according to the third embodiment of the present invention.

FIG. 18 illustrates generation of a scrambling code at a time point other than a frame boundary using masking according to the fourth embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

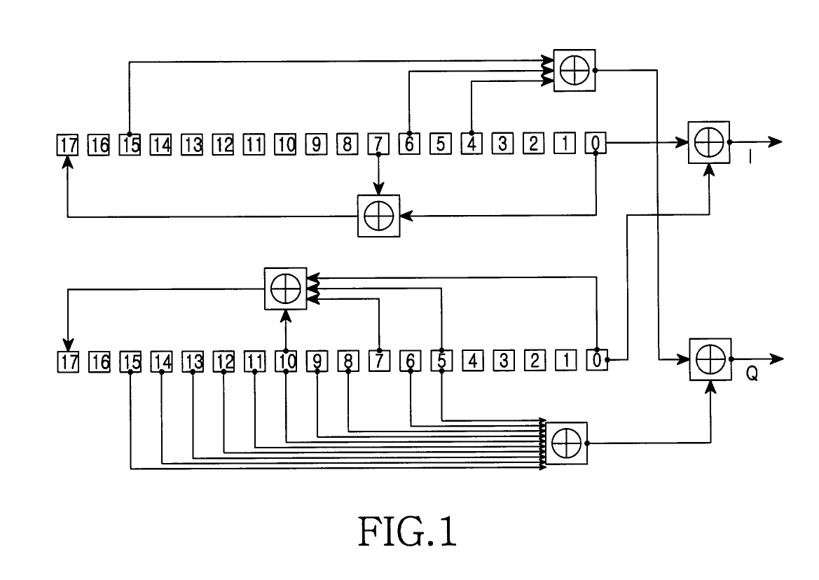

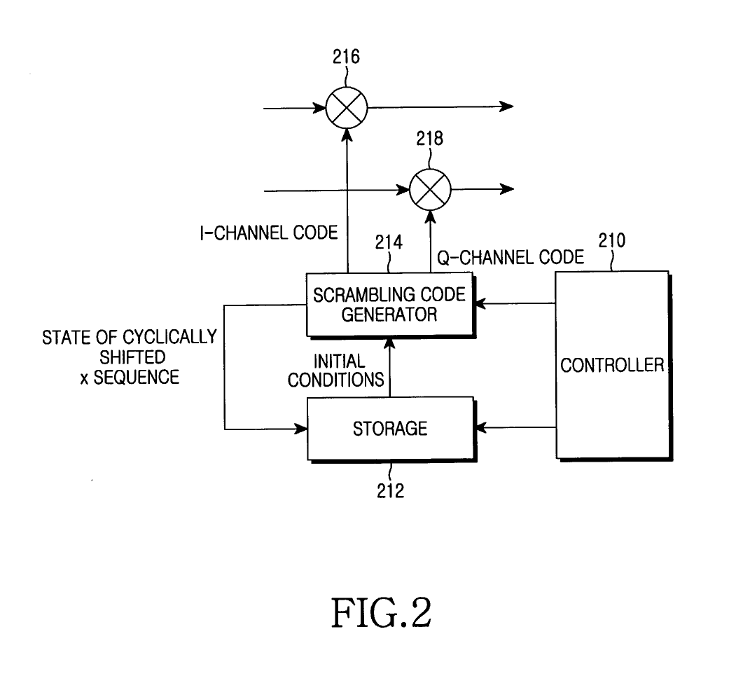

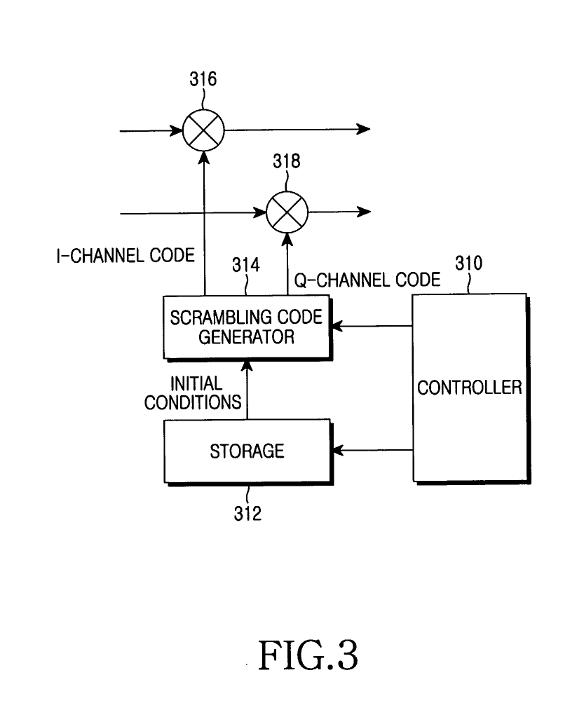

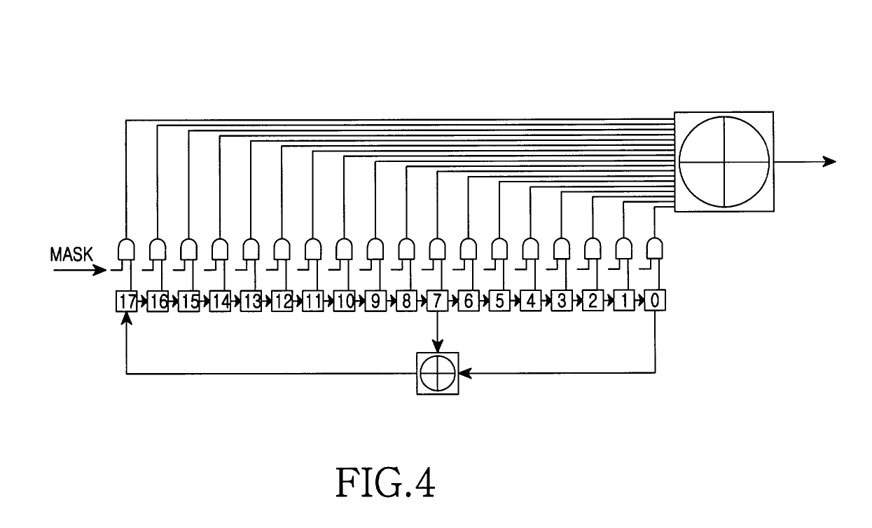

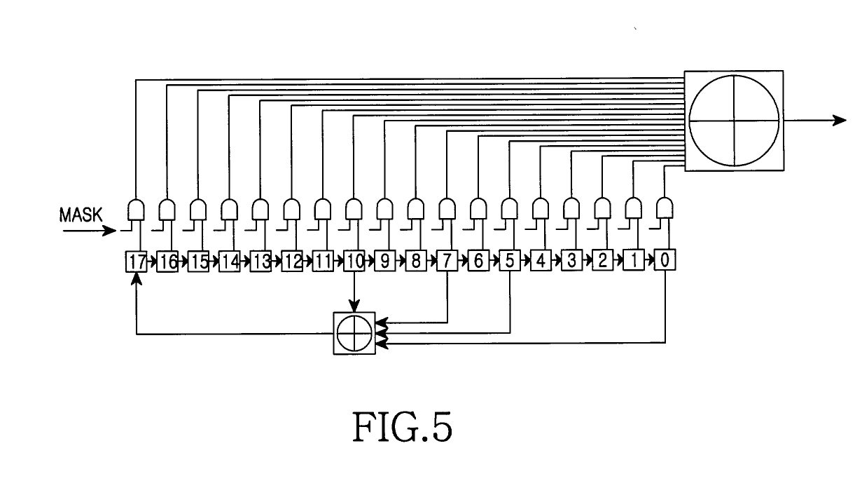

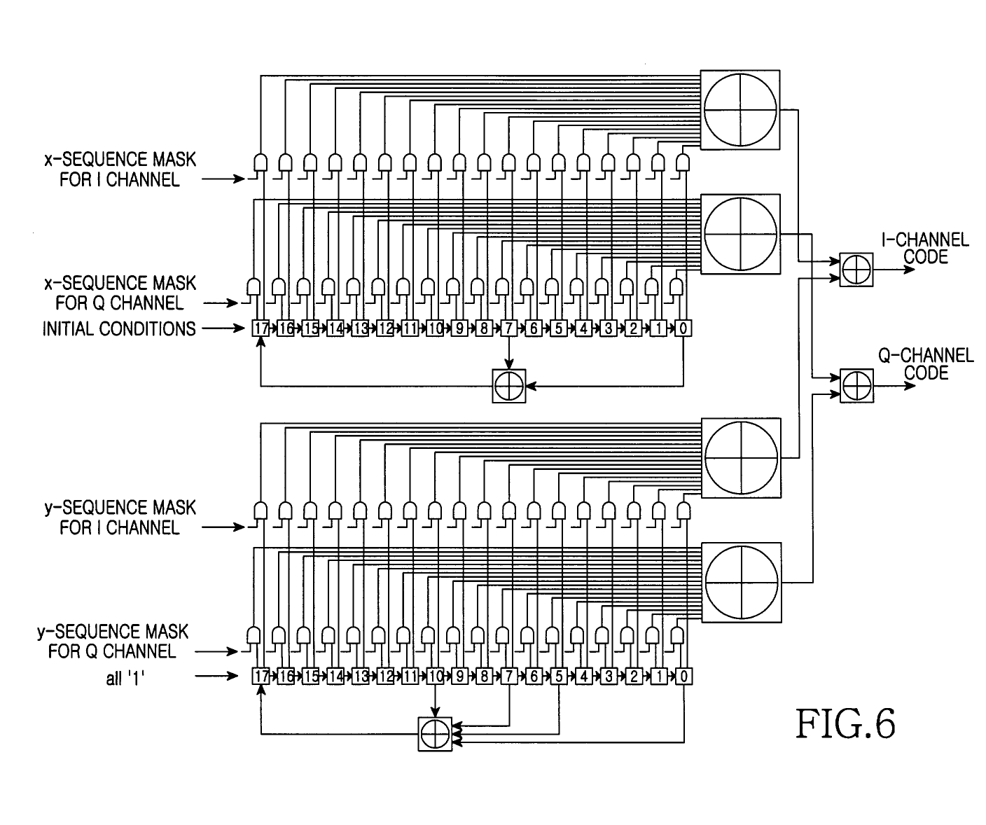

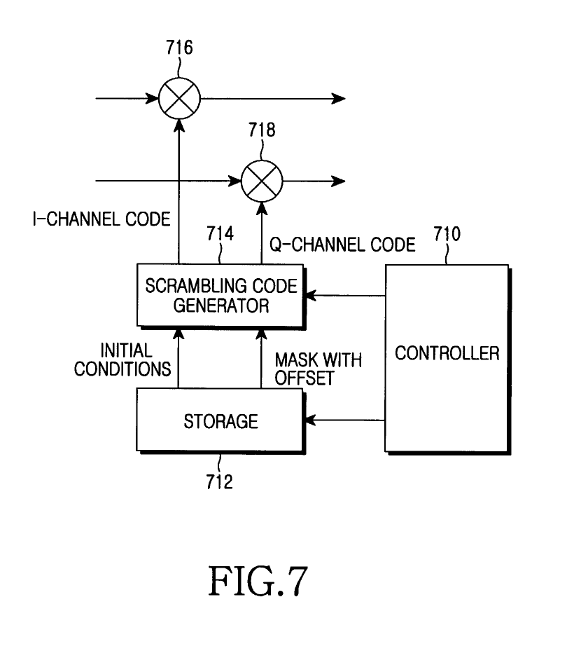

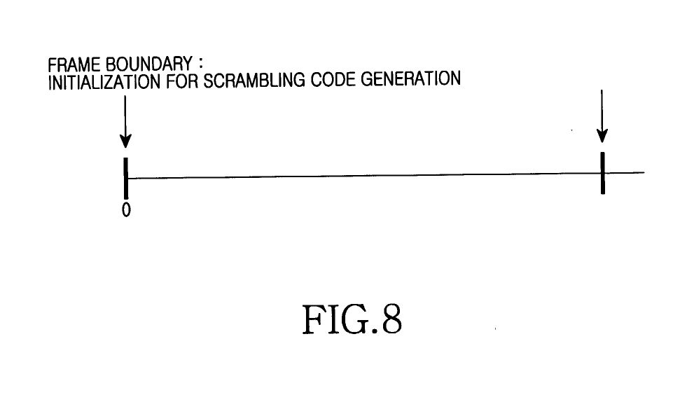

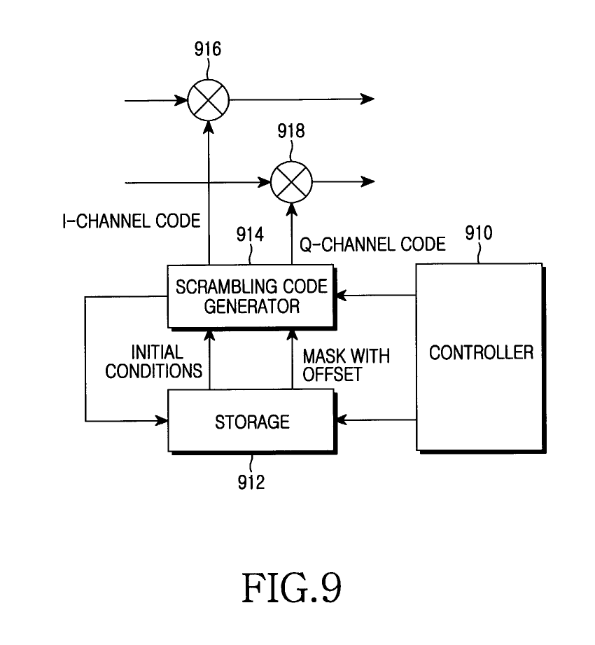

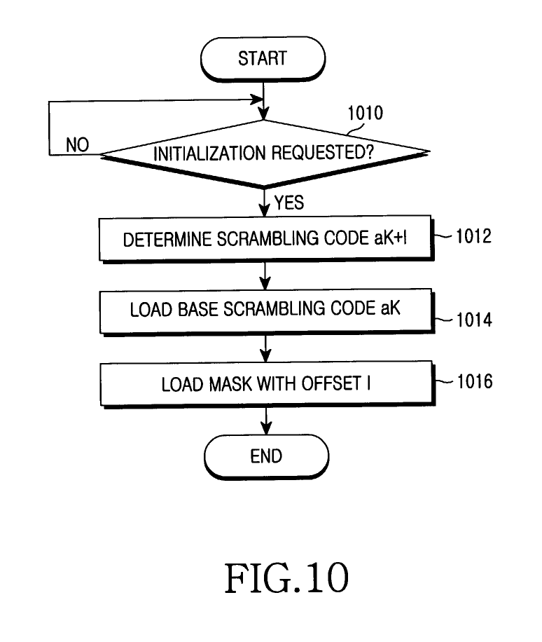

FIG. 9 is a block diagram of a scrambling code generating apparatus in a CDMA mobile communication system according to the present invention. The scrambling code generating apparatus uses the scrambling code generator illustrated in FIG. 1 or FIG. 6 depending on whether scrambling code masking is employed or not.

Referring to FIG. 9, upon request of initialization for scrambling code generation, a controller 910 determines which scrambling code to generate and provides overall control in relation to generation of the determined scrambling code. A storage 912 has minimum initial conditions required to generate scrambling codes and outputs corresponding to initial conditions under the control of the controller 910. The initial conditions stored in the storage 912 vary according to embodiments of the present invention. For example, the initial conditions can be a predetermined number of scrambling codes and masks with offsets. The storage 912 stores a scrambling code received from a scrambling code generator 914 for use in re-initialization. The scrambling code generator 914 generates the determined scrambling code using a base scrambling code and a mask with a corresponding offset as initial conditions received from the storage 912, or by cyclically shifting an x sequence received as an initial condition from the storage 912 a predetermined number of times. The scrambling code are fed to a first multiplier 916 and a second multiplier 918, respectively, for generating I-channel and Q-channel scrambling sequences and the I-channel and Q-channel scrambling sequences are used for data spreading and despreading.

To briefly describe four embodiments of the present invention, (1) a predetermined number of base scrambling codes and masks with corresponding offsets are stored as initial conditions and an intended scrambling code is generated by masking a base scrambling code with a mask during initialization in the first embodiment; (2) a number of predetermined base scrambling codes are stored as initial conditions and an intended scrambling code is generated by cyclically shifting a base scrambling code an appropriate number of times during initialization in the second embodiment; (3) a predetermined number of scrambling codes and masks different from those used in the first embodiment are stored as initial conditions and an intended scrambling code is generated by masking a base scrambling code with a mask during initialization in the third embodiment; and (4) a predetermined number of base scrambling codes and masks are stored as initial conditions and an intended scrambling code is generated by masking a base scrambling code with a mask and cyclically shifting the resulting scrambling code during initialization in the fourth embodiment.

First Embodiment

FIG. 10 is a flowchart illustrating an embodiment of scrambling code generation according to the present invention. To generate scrambling codes according to the embodiment of the present invention, a predetermined number of scrambling codes and masks are stored in the storage 912. The scrambling codes are spaced at predetermined intervals K among all scrambling codes (8192 scrambling codes in a normal mode and 24576 scrambling codes in a compressed mode). The number of required masks is determined by the interval K. As the interval K increases, the number of masks as initial conditions increases, and as the interval K decreases, the number of masks decreases. In other words, as the interval K increases, the number of base scrambling codes decreases and as the interval K decreases, the number of the base scrambling codes increases. Therefore, it is preferable to set K to an appropriate value to generate scrambling codes fast using minimum initial conditions.

Referring to FIG. 10, upon request of initialization for scrambling code generation in step 1010, the controller 910 determines which scrambling code to generate in step 1012. A scrambling code is unique to a specific Node B and information about the scrambling code is received from the Node B before the initialization. Here, a scrambling code k is expressed as a scrambling code aK+1.

Then the controller 910 commands the storage 912 to load a base scrambling code aK according to the scrambling code aK+1 in step 1014 and commands the storage 912 to load a mask with offset 1 according to the scrambling code aK+1 in step 1016. The scrambling code generator 914 generates the scrambling code aK+1 by masking the base scrambling code aK with the mask with offset 1. Since masking is used to generate a scrambling code, the scrambling code generator 914 is configured as illustrated in FIG. 6. Specifically, to generate the scrambling code aK+1, the scrambling code generator 914 sets the base scrambling code aK in its internal delays and operates EX-OR calculation with the contents of the delays and the mask with offset 1, thus generating x sequences and y sequences for I-channel and Q-channel scrambling sequences.

In accordance with the embodiment of the present invention, a predetermined number of base scrambling codes spaced from each other by K (constant) and x-sequence masks with offsets below K, that is, offset 1 to offset (K−1) are stored. That is, the base scrambling codes have indexes being K multiples. A base scrambling code having the highest index substantially equal or lower than the index of an intended scrambling code is selected and an x-sequence mask with the offset between the base scrambling code and the intended scrambling code is applied during an initialization process.

Table 1 below lists base scrambling codes and x-sequence masks with corresponding offsets as initial conditions stored in the storage 912 and scrambling codes that can be generated using the initial conditions.

TABLE 1

| Base | | |
|---|---|---|
| scrambling code | x-sequence mask offset | Scrambling code |
| Scrambling code 0 | — | Scrambling code 0 |
| | Mask offset 1 | Scrambling code 1 |
| | Mask offset 2 | Scrambling code 2 |
| | . | . |
| | . | . |
| | . | . |
| | Mask offset K − 1 | Scrambling code K − 1 |
| Scrambling code K | — | Scrambling code K |
| | Mask offset 1 | Scrambling code K + 1 |
| | Mask offset 2 | Scrambling code K + 2 |
| | . | . |
| | . | . |
| | . | . |
| | Mask offset K − 1 | Scrambling code 2K − 1 |
| . | . | . |
| . | . | . |
| . | . | . |
| Scrambling code aK | — | Scrambling code aK |
| | Mask offset 1 | Scrambling code aK + 1 |
| | Mask offset 2 | Scrambling code aK + 2 |
| | . | . |
| | . | . |
| | . | . |
| | Mask offset 1 | Scrambling code aK + 1 |
| | . | . |
| | . | . |
| | . | . |
| | Mask offset K − 1 | Scrambling code |
| | | (a + 1)K − 1 |

Given the scrambling code interval K, 8192/K scrambling codes and (K-1) mask offsets, offset 1 to offset (K−1) are stored as initial conditions in the storage 912, although the (K−1) mask offsets are mapped to each scrambling code initial condition in Table 1 for clarity of description. It can be further contemplated that K mask offsets from mask offset 0 to mask offset (K−1) can be used as initial conditions.

A scrambling code k to be generated is generalized as

k=aK+1 (8)

where a=0, 1, 2, . . . , K is a constant, and 1=0, 1, 2, . . . , K−1.

If K is 16, only primary scrambling codes and 15 mask offsets are used as initial conditions to generate scrambling codes between arbitrary primary scrambling codes.

The index k of a scrambling code needs to be changed to the form of aK+1, where a and 1 are defined to be the quotient and remainder of dividing k by the scrambling code interval K, respectively. Mask offset 1 indicates a mask with an 1-chip offset.

To generate a scrambling code K+2, the controller 910 controls the storage 912 to load a base scrambling code K as an initial condition to the scrambling code generator 914. The scrambling code K is set in the delays of the scrambling code generator 914. Then the controller 910 controls the storage 912 to load a mask with offset 2 to the scrambling code generator 914. The scrambling code generator 914 generates the scrambling code K+2 by masking the base scrambling code K with the mask with offset 2. Accordingly, the other scrambling codes in Table 1 can also be generated in the same manner.

The same scrambling code can be generated by changing the loading sequence, that is, by first loading a mask and then loading a base scrambling code. While the above description has been made in the context of x sequences, it is to be noted that y sequences are also used in the same manner except that no masking is adopted, i.e., mask offset 0 is used to generate the y sequences.

Second Embodiment

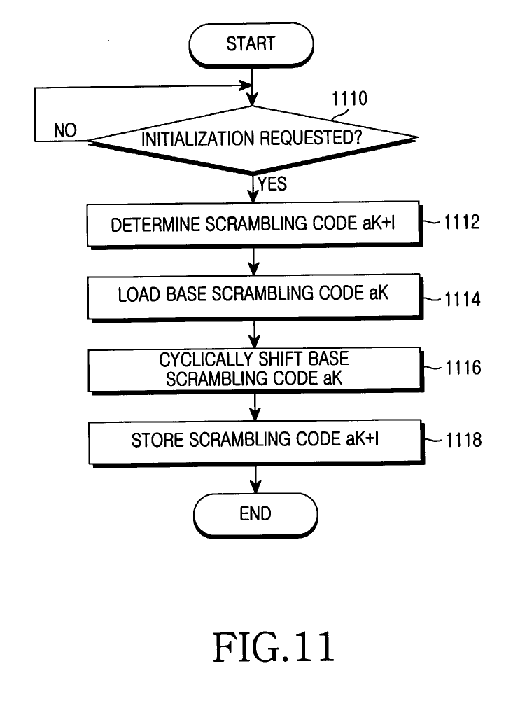

FIG. 11 is a flowchart illustrating another embodiment of scrambling code generation according to the present invention. To generate scrambling codes according to the second embodiment of the present invention, a predetermined number of base scrambling codes are stored as initial conditions in the storage 912. The scrambling codes are spaced at predetermined intervals K among the 8192 scrambling codes. The controller 910 determines the number of cyclic shifts to be made on an x sequence according to the interval K to generate an intended scrambling code and controls the cyclic shifting of the scrambling code generator 914 correspondingly.

Referring to FIG. 11, the controller 901 determines whether initialization is to be carried out for scrambling code generation in step 1110. The initialization occurs at the start point of a frame.

Upon request of the initialization, the controller 910 determines which scrambling code to generate in step 1112. The index k of the scrambling code is expressed in the form of aK+1 in FIG. 11.

In step 1114, the controller 910 commands the storage 912 to load a corresponding base scrambling code aK to the scrambling code generator 914. The controller 910 determines the number 1 of cyclic shifts to generate the scrambling code aK+1 in step 1116.

Then the scrambling code generator 914 generates the scrambling code aK+1 by shifting the base scrambling code aK 1 times. Since cyclic shifting is adopted for scrambling code generation, the scrambling code generator 914 is configured as illustrated in FIG. 1. Specifically, the scrambling code generator 914 sets the base scrambling code aK in its internal delays and cyclically shifts the contents of x-sequence delays 1 times under the control of the controller 910.

In accordance with the second embodiment of the present invention, base scrambling codes spaced by an interval K are stored. That is, the base scrambling codes have indexes being K multiples. A base scrambling code having the highest index substantially equal or lower than the index of an intended scrambling code is selected and the x sequence of the base scrambling code is cyclically shifted as many times as the offset between the base scrambling code and the intended scrambling code during an initialization process.

Table 2 below lists base scrambling codes stored as initial conditions in the storage 912 and scrambling codes that can be generated by cyclically shifting the base scrambling codes.

TABLE 2

| | Number | |
|---|---|---|
| | of x-sequence | |
| Base scrambling code | cyclic shifts | Scrambling code |
| Scrambling code 0 | — | Scrambling code 0 |
| | Cyclic shift 1 | Scrambling code 1 |
| | Cyclic shift 2 | Scrambling code 2 |
| | . | . |
| | . | . |
| | . | . |
| | Cyclic shift K − 1 | Scrambling code K − 1 |
| Scrambling code K | — | Scrambling code K |
| | Cyclic shift 1 | Scrambling code K + 1 |
| | Cyclic shift 2 | Scrambling code K + 2 |
| | . | . |
| | . | . |
| | . | . |
| | Cyclic shift K − 1 | Scrambling code 2K − 1 |
| . | . | . |
| . | . | . |
| . | . | . |
| Scrambling code aK | — | Scrambling code aK |
| | Cyclic shift 1 | Scrambling code aK + 1 |
| | Cyclic shift 2 | Scrambling code aK + 2 |
| | . | . |
| | . | . |
| | . | . |
| | Cyclic shift 1 | Scrambling code aK + 1 |
| | . | . |
| | . | . |
| | . | . |
| | Cyclic shift K − 1 | Scrambling code (a + 1)K − 1 |

Given the scrambling code interval K, 8192/K base scrambling codes are stored as initial conditions in the storage 912 and the number of required cyclic shifts ranges from 1 to (K−1).

A scrambling code k to be generated is generalized by k=aK+1 as in the first embodiment. If K is 16, only primary scrambling codes are stored as initial conditions. To generate a scrambling code between two arbitrary primary scrambling codes, cyclic shift occurs once to 15 times according to the intended scrambling code. Cyclic shift 1 means one occurrence of cyclic shift.

To generate a scrambling code K+2, the controller 910 controls the storage 912 to load a base scrambling code K as an initial condition to the scrambling code generator 914. The base scrambling code K is set in the delays of the scrambling code generator 914. Then the controller 910 determines the number of cyclic shifts required to generate the scrambling code K+2 using the initial condition. The scrambling code generator 914 generates the scrambling code K+2 by cyclically shifting the base scrambling code K the predetermined number of times. Accordingly, the other scrambling codes in Table 2 can also be generated in the same manner.

While the above description has been made in the context of x sequences, it is to be noted that y sequences are also used in the same manner except that cyclic shifting is not applied to the y sequences.

Third Embodiment

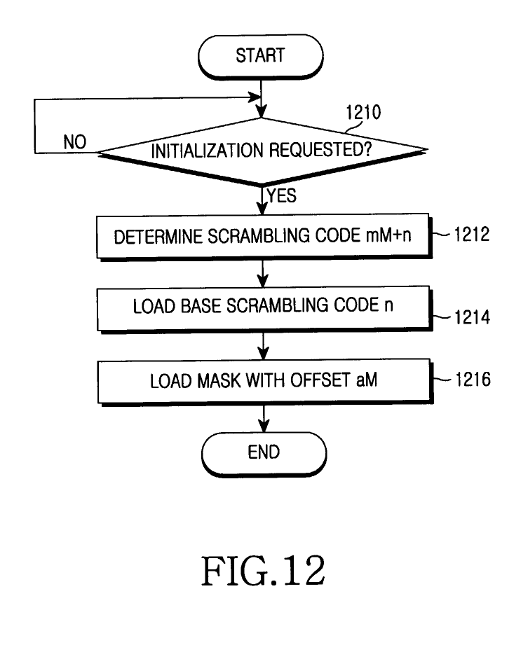

FIG. 12 is a flowchart illustrating a third embodiment of scrambling code generation according to the present invention. To generate scrambling codes according to the third embodiment of the present invention, a predetermined number of, that is, M base scrambling codes and a predetermined number of, that is, m mask offsets are stored as initial conditions in the storage 912. The first M scrambling codes are chosen from the 8192 scrambling codes and the number m of the mask offsets is determined by the quotient of dividing 8192 by the number M of the selected base scrambling codes. As M decreases and thus the quotient increases, m increases, and as M increases and thus the quotient decreases, m decreases. Therefore, it is preferable to set M to an appropriate value to generate scrambling codes fast using minimum initial conditions.

Referring to FIG. 12, upon request of initialization for scrambling code generation in step 1210, the controller 910 determines which scrambling code to generate in step 1212. The initialization occurs at a frame boundary. A scrambling code is unique to a specific Node B and its information is received from the Node B before the initialization. The index k of a scrambling code is expressed here in the form of mM+n.

Then the controller 910 commands the storage 912 to load a base scrambling code n according to the scrambling code mM+n in step 1214. After loading the base scrambling code n, the controller 910 commands the storage 912 to load a mask with offset aM according to the scrambling code mM+n in step 1216. The scrambling code generator 914 generates the scrambling code mM+n by masking the base scrambling code n with the mask with offset aM. Since masking is used to generate a scrambling code, the scrambling code generator 914 is configured as illustrated in FIG. 6.

In accordance with the third embodiment of the present invention, the first M ones of the 8192 scrambling codes and x-sequence masks with offsets being M multiples are stored as initial conditions. A base scrambling code having an index being the modulo M of the index of an intended scrambling code and an x-sequence mask with the highest offset equal to or lower than the index of the intended scrambling code are used during an initialization process.

Table 3 below lists initial conditions stored in the storage 912 and scrambling codes that can be generated using the initial conditions. As stated before, the initial conditions are base scrambling codes and x-sequence masks.

TABLE 3

| | x-sequence | |
|---|---|---|
| Base scrambling code | mask offset | Scrambling code |
| Scrambling code 0 | — | Scrambling code 0 |
| Scrambling code 1 | | Scrambling code 1 |
| . | | . |
| . | | . |
| . | | . |
| Scrambling code n | | Scrambling code n |
| . | | . |
| . | | . |
| . | | . |
| Scrambling code M − 1 | | Scrambling code M − 1 |
| Scrambling code 0 | Mask offset M | Scrambling code M |
| Scrambling code 1 | | Scrambling code M + 1 |
| . | | . |
| . | | . |
| . | | . |
| Scrambling code n | | Scrambling code M + n |
| . | | . |
| . | | . |
| . | | . |
| Scrambling code M − 1 | | Scrambling code 2M − 1 |
| Scrambling code 0 | Mask offset 2M | Scrambling code 2M |
| Scrambling code 1 | | Scrambling code 2M + 1 |
| . | | . |
| . | | . |
| . | | . |
| Scrambling code n | | Scrambling code 2M + n |
| . | | . |
| . | | . |
| . | | . |
| Scrambling code M − 1 | | Scrambling code 3M − 1 |
| . | . | . |
| . | . | . |
| . | . | . |
| Scrambling code 0 | Mask offset mM | Scrambling code mM |
| Scrambling code 1 | | Scrambling code mM + 1 |
| . | | . |
| . | | . |
| . | | . |
| Scrambling code n | | Scrambling code mM + n |
| . | | . |
| . | | . |
| . | | . |
| Scrambling code M − 1 | | Scrambling code |
| | | (m + 1)M − 1 |

In Table 3, the first M ones of the 8192 scrambling codes are defined as base scrambling codes. Thus 8192/M scrambling codes and m mask being M multiples, offset 0 to offset mM are stored as initial conditions in the storage 912, although scrambling code 0 to scrambling code M−1 are mapped to each mask offset in Table 3 for clarity of description.

A scrambling code k to be generated is generalized as

k=mM+n (9)

where m=0, 1, 2, . . . , M is the first mask offset, n is a base scrambling code, and n<M.

In this embodiment, the index k of a scrambling code needs to be changed to the form of mM+n. The Mask mM indicates a mask with an mM-chip offset.

To generate a scrambling code 2M+1, the controller 910 controls the storage 912 to load a base scrambling code 1 as an initial condition to the scrambling code generator 914. The base scrambling code 1 is set in the delays of the scrambling code generator 914. Then the controller 910 controls the storage 912 to load a mask with offset 2M to the scrambling code generator 914. The scrambling code generator 914 generates the scrambling code 2M+1 by masking the base scrambling code 1 with the mask with offset 2M. Accordingly, the other scrambling codes in Table 3 can also be generated in the same manner.

The same scrambling code is generated by changing the loading sequence, that is, by first loading a mask and then loading a base scrambling code. While the above description has been made in the context of x sequences, it is to be noted that y sequences are also used in the same manner except that mask offset 0 is applied to generate the y sequences. The initialization occurs at each frame boundary.

Fourth Embodiment

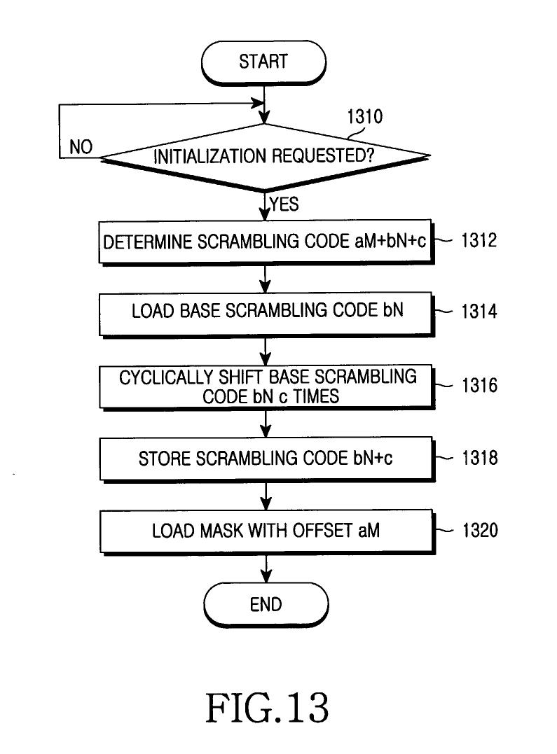

FIG. 13 is a flowchart illustrating a fourth embodiment of scrambling code generation according to the present invention. To generate scrambling codes according to the fourth embodiment of the present invention, a predetermined number of base scrambling codes and a predetermined number of masks are stored as initial conditions in the storage 912. The base-scrambling codes are spaced at predetermined intervals N among the 8192 scrambling codes and the masks have offsets aM (a is 0 or a positive integer). The controller 910 determines the number of cyclic shifts to be performed on a base scrambling code according to the interval N to generate an intended scrambling code and controls the cyclic shifting of the scrambling code generator 914 correspondingly. If N=16, the number of cyclic shifts ranges 0 to 15. As N increases, the maximum number of cyclic shifts increases, and as N decreases, the maximum number of cyclic shifts decreases. In the former case, the number of base scrambling codes is decreased and in the latter case, it is increased. Therefore, it is preferable to set N to an appropriate value to generate scrambling codes fast using minimum initial conditions.

Referring to FIG. 13, the controller 901 determines whether initialization is required to generate a scrambling code in step 1310. The initialization occurs at the start point of a frame.

Upon request of the initialization, the controller 910 determines which scrambling code to generate in step 1312. The UE receives information about the scrambling code from a corresponding Node B before the initialization process. The index k of a scrambling code is expressed in the form of aM+bN+c in FIG. 13.

In step 1314, the controller 910 commands the storage 912 to load a corresponding initial condition, that is, a corresponding base scrambling code bN to the scrambling code generator 914. The controller 910 determines the number c of cyclic shifts and the scrambling code generator 914 cyclically shifts the base scrambling code bN c times in step 1316. In step 1318, the scrambling code generator 914 provides the resulting x sequence to the storage 912, so that the x sequence can be used as an initial condition for another initialization at a frame boundary.

Then the controller 910 commands the storage 912 to load a mask with offset aM to the scrambling code generator 914 in step 1320. The scrambling code generator 912 generates the scrambling code aM+bN+c by masking the x sequence using the mask with offset aM. If a is 0, the scrambling code bN+c generated in step 1316 is output as the scrambling code aM+bN+c. Since cyclic shifting and masking are adopted for scrambling code generation, the scrambling code generator 914 is configured as illustrated in FIG. 6.

In accordance with the fourth embodiment of the present invention, to generate scrambling codes the scrambling codes are spaced at predetermined intervals N among the first M ones of the 8192 scrambling codes. And the number of required masks is determined by the interval M. Here, the base scrambling codes are spaced at predetermined intervals N (constant) and a is 0 or a positive integer in the mask offsets aM. In other words, the mask offsets are set on an M-chip basis. To generate an intended scrambling code, a base scrambling code with the highest index equal to or lower than the modulo M of the index of the intended scrambling code is loaded and the x sequence of the base scrambling code is cyclically shifted as many times as the difference between the index of the base scrambling code and the modulo M of the index of the intended scrambling code. Then the intended scrambling code is generated by masking the resulting scrambling code with a mask with the highest offset equal to or lower than the index of the intended scrambling code.

Table 4 below lists base scrambling codes and x-sequence masks stored as initial conditions in the storage 912 and scrambling codes that can be generated by combining the initial conditions and numbers of cyclic shifts.

TABLE 4

| Base | Number of x- | First | | |
|---|---|---|---|---|
| scrambling | sequence | scrambling | x-sequence | Second |
| code | cyclic shifts | code | mask offset | scrambling code |
| SC_0 | — | SC_0 | Mask offset | SC_aM |
| | | | aM | |
| | Cyclic shift 1 | SC_1 | Mask offset | SC_aM + 1 |
| | | | aM | |
| | Cyclic shift 2 | SC_2 | Mask offset | SC_aM + 2 |
| | | | aM | |
| | . | . | . | . |
| | . | . | . | . |
| | . | . | . | . |
| | Cyclic shift | SC_N − 1 | Mask offset | SC_aM + N − 1 |
| | N − 1 | | aM | |
| SC_N | — | SC_N | Mask offset | SC_aM + N |
| | | | aM | |
| | Cyclic shift 1 | SC_N + 1 | Mask offset | SC_aM + N + 1 |
| | | | aM | |
| | Cyclic shift 2 | SC_N + 2 | Mask offset | SC_aM + N + 2 |
| | | | aM | |
| | . | . | . | . |
| | . | . | . | . |
| | . | . | . | . |
| | Cyclic shift | SC_2N − 1 | Mask offset | SC_aM + 2N − 1 |
| | N − 1 | | aM | |
| . | . | . | . | . |
| . | . | . | . | . |
| . | . | . | . | . |
| SC_bN | — | SC_bN | Mask offset | SC_aM + bN |
| | | | aM | |
| | Cyclic shift 1 | SC_bN + 1 | Mask offset | SC_aM + bN + 1 |
| | | | aM | |
| | Cyclic shift 2 | SC_bN + 2 | Mask offset | SC_aM + bN + 2 |
| | | | aM | |
| | . | . | . | . |
| | . | . | . | . |
| | . | . | . | . |
| | Cyclic shift c | SC_bN + c | Mask offset | SC_aM + bN + c |
| | | | aM | |
| | . | . | . | . |
| | . | . | . | . |
| | . | . | . | . |
| | Cyclic shift | SC_bN − 1 | Mask offset | SC_aM + (b + 1)N − 1 |
| | N − 1 | | aM | |
| . | . | . | . | . |
| . | . | . | . | . |
| . | . | . | . | . |
| SC_(L − 1)N | — | SC_(L − 1)N | Mask offset | SC_aM + (L − 1)N |
| | | | aM | |
| | Cyclic shift 1 | SC_(L − 1)N + 1 | Mask offset | SC_aM + (L − 1)N + 1 |
| | | | aM | |
| | Cyclic shift 2 | SC_(L − 1)N + 2 | Mask offset | SC_aM + (L − 1)N + 2 |
| | | | aM | |
| | . | . | . | . |
| | . | . | . | . |
| | . | . | . | . |
| | Cyclic shift | SC_LN − 1 | Mask offset | SC_aM + LN − 1 |
| | N − 1 | | aM | |

The base scrambling codes are spaced by the interval N and mask offsets are 0 or an M multiple. Thus, L scrambling codes among the M scrambling codes and up to 8192/M mask offsets are stored as initial conditions in the storage 912 and the number of cyclic shifts ranges from 1 to (N−1).

A scrambling code k to be generated is generalized by

k=aM+bN+c (10)

where a=0, 1, 2, . . . , N=M/L, b<L, and c<N.

To generate a scrambling code k, the controller 910 needs to convert the index k in the form of aM+bN+c. Here, a mask with offset aM means a mask with an offset of aM chips.

When a scrambling code aM+bN+c is to be generated, the controller 910 controls the storage 912 to load a base scrambling code bN as an initial condition to the scrambling code generator 914. The scrambling code bN is set in the delays of the scrambling code generator 914. Then the scrambling code generator 914 generates a scrambling code bN+c by cyclically shifting the loaded scrambling code bN c times. The controller 910 commands the storage 912 to load a mask with offset aM to the scrambling code generator 914 and the scrambling code generator 914 generates the scrambling code aM+bN+c by masking the scrambling code bN+c with the mask with offset aM.

The other scrambling codes in Table 4 are generated in the same manner and the same scrambling code can be generated by changing the loading sequence, that is, first loading a mask and then loading a base scrambling code. While the above description has been made in the context of x sequences for I and Q channels, the same thing applies to y sequences.

It has been described that initialization for scrambling code generation is carried out at a frame boundary only in the above four embodiments of the present invention. The resulting decrease in cell search speed can be prevented by adopting a masking technique.

Referring to FIG. 6, an x-sequence mask and a y-sequence mask for an I channel are “000000000000000001” and “000000000000000001” with their MSBs being 0s, and an x-sequence mask and a y-sequence mask for a Q channel are “001000000001010000” and “001111111101100000”, respectively. Using these masks, the scrambling code generator produces the same scrambling codes as the scrambling code generator illustrated in FIG. 1.

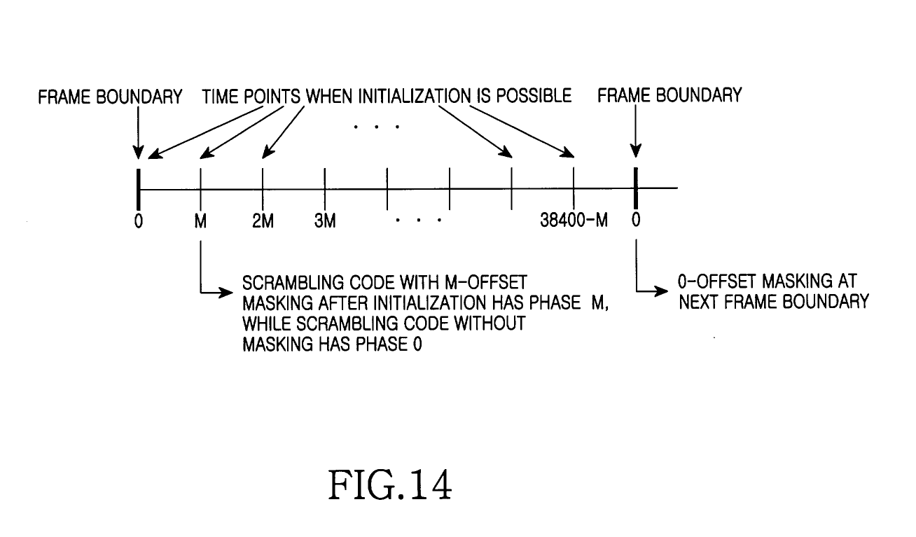

With the masking technique illustrated in FIG. 14, a scrambling code with an offset from a frame boundary is generated at an arbitrary time point. In other words, a scrambling code can be generated at any time point apart from the frame boundary on an offset basis. For example, if masking is applied on an M-chip basis, a scrambling code is generated at a time point spaced from the frame boundary by M-multiple chips. Although a scrambling code generated at the frame boundary has phase 0 without masking and a scrambling code generated at an M-chip time point from the frame boundary has phase M, they are eventually equivalent. In Universal Mobile Telecommunications Systems (UMTS), a scrambling code has a period of 38400 chips and thus initialization occurs every 38400 chips. At the next frame boundary, a mask with offset 0 is applied.

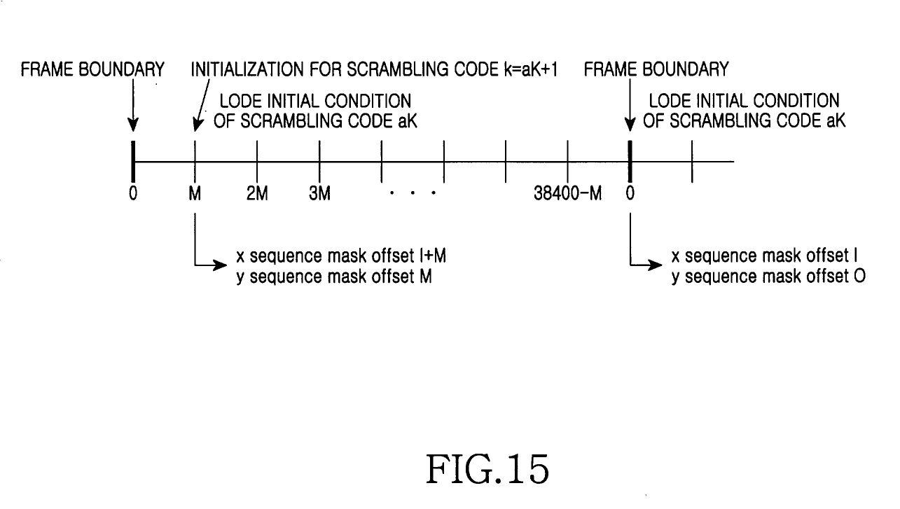

FIG. 15 illustrates masking to generate a scrambling code at a time point having a specific offset from a frame boundary according to the first embodiment of the present invention. Referring to FIG. 15, an x-sequence mask with an offset of mM to (mM+K−1) and a y-sequence mask with an offset of mM are used to generate a scrambling code at a time point spaced from the frame boundary by mM chips. Here, m=0, 1, . . . , (38400/M)-1. For example, if M-chip offset masking is applied to a scrambling code K+2, the initial conditions of a scrambling code k are loaded and (M+2)-chip offset masking is applied to x sequences and M-chip offset masking is applied to y sequences. At a frame boundary, the initial conditions of the scrambling code K are loaded and 2-chip offset masking and O-chip offset masking are applied to x sequences and y sequences, respectively.

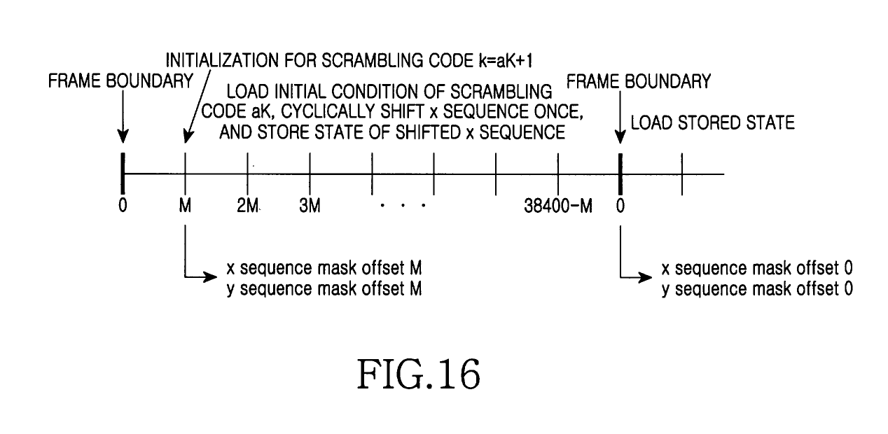

FIG. 16 illustrates masking to generate a scrambling code at a time point having a specific offset from a frame boundary according to the second embodiment of the present invention. Referring to FIG. 16, an x-sequence mask with an M-chip offset and a y-sequence mask with an M-chip offset are used to generate a scrambling code K+1 with an M-chip offset after initialization. At a frame boundary, the initial conditions are loaded to the x-sequence generator 914 and masked with 0-chip offset x-sequence and y-sequences masks.

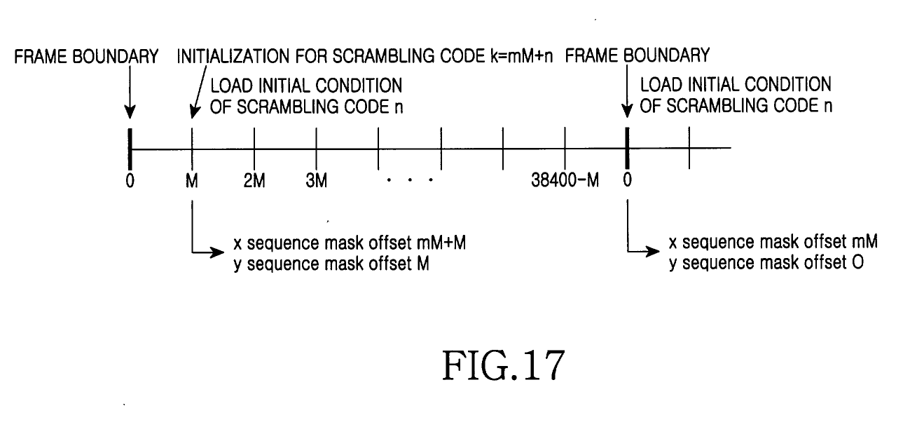

FIG. 17 illustrates masking to generate a scrambling code at a time point having a specific offset from a frame boundary according to the third embodiment of the present invention. Referring to FIG. 17, when 1-chip offset masking (1=i×M, i=0, 1, 2 . . . ) is used to generate a scrambling code mM+n, a base scrambling code n is used as an initial condition in the x-sequence generator and an x-sequence mask and a y-sequence mask have an (m+i)×M chip-offset and an i×M chip-offset, respectively. In FIG. 17, i=1. At a frame boundary, an m×M-chip offset mask and a 0-chip mask are applied to x-sequences and y-sequences, respectively.

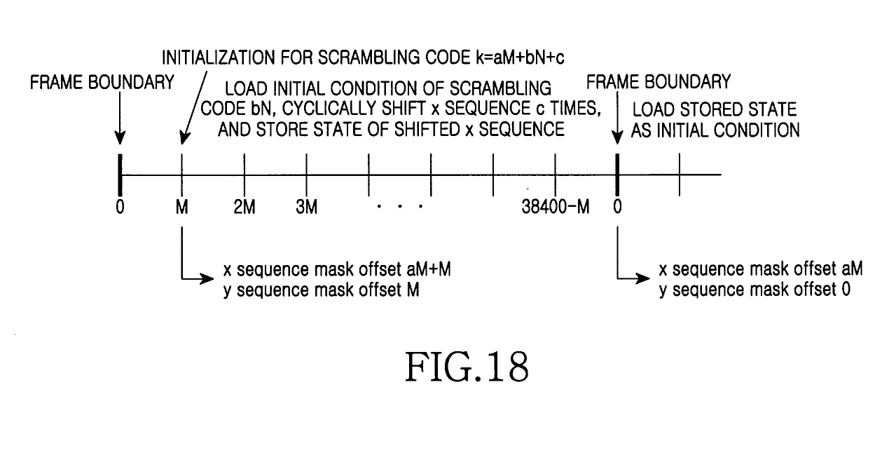

FIG. 18 illustrates masking to generate a scrambling code at a time point having a specific offset from a frame boundary according to the fourth embodiment of the present invention. Referring to FIG. 18, when a scrambling code aM+bN+c is generated at a time point spaced from the frame boundary by 1 chips (1=i×M, i=0, 1, 2 . . . ), a base scrambling code bN is loaded as an initial condition and the x sequence of the scrambling code bN is shifted c times. Since the state of the x-sequence generator is used as the initial condition of the scrambling code aM+bN+c at another initialization. Here, an x-sequence mask has an offset of (a+i)×M chips and a y-sequence mask has an offset of ixM chips. In FIG. 18, i=1. At the next frame boundary, an mxM-chip offset mask and a 0-chip mask are applied to x-sequences and y-sequences, respectively.

In accordance with the present invention, initialization for scrambling code generation is performed in a shorter time. Especially, memory requirement can be reduced without a performance decrease, as compared to the method of generating scrambling codes only relying on their stored initial conditions. Furthermore, use of masking enables a scrambling code to be generated at any time point other than a frame boundary, thus reducing cell search time.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of generating a scrambling code through initialization in a CDMA mobile communication system where a predetermined number of base scrambling codes having indexes being K multiples (K is a constant) and masks with offsets below K are stored as initial conditions, the method comprising the steps of:
loading a base scrambling code having the highest index substantially equal to or lower than the index of an intended scrambling code to be generated;
loading a mask having an offset corresponding to the difference between the indexes of the base scrambling code and the intended scrambling code; and
generating the intended scrambling code by masking the base scrambling code with the loaded mask.

2. The method of claim 1, wherein the initialization for generating the scrambling code is carried out at each frame boundary.

3. The method of claim 1, wherein the scrambling code is generated at a time point having a specific offset from a frame boundary.

4. The method of claim 1, wherein the step of loading a mask having an offset of zero for y-sequences.

5. An apparatus for generating a scrambling code through initialization in a DMA mobile communication system, comprising;
a storage for storing a predetermined number of base scrambling codes having indexes eing K multiples (K is a constant) and masks with offsets below K as initial conditions and utputting a base scrambling code and a mask in response to a load command from a controller;
the controller for, upon request of initialization for scrambling code generation, ommanding the storage to load a base scrambling code having the highest index equal to or lower than the index of an intended scrambling code to be generated and a mask having an offset corresponding to the difference between the indexes of the base scrambling code and the intended scrambling code; and
a scrambling code generator for generating the intended scrambling code by masking the base scrambling code with the loaded mask.

6. The apparatus of claim 5, wherein the initialization for generating the scrambling code is carried out at each frame boundary.

7. The apparatus of claim 5, wherein the scrambling code is generated at a time point having a specific offset from a frame boundary.

8. A method of generating a scrambling code through initialization in a CDMA mobile communication system where a predetermined number of base scrambling codes having indexes being K multiples (K is a constant) are stored as initial conditions, the method comprising the steps of:
loading a base scrambling code having the highest index substantially equal to or lower than the index of an intended scrambling code to be generated; and
generating the intended scrambling code by cyclically shifting the base scrambling code as many times as the difference between the indexes of the base scrambling code and the intended scrambling code.

9. The method of claim 8, wherein the initialization for generating the scrambling code is carried out at each frame boundary.

10. The method of claim 8, wherein the scrambling code is generated at a time point having a specific offset from a frame boundary.

11. The method of claim 10, further comprising the step of storing the generated scrambling code for use in a next initialization.

12. The method of claim 8, wherein in the generating the intended scrambling code step, in the case of generating a y-sequence, cyclically shifting the base code is excluded.

13. An apparatus for generating a scrambling code through initialization in a CDMA mobile communication system, comprising;
a storage for storing a predetermined number of base scrambling codes having indexes being K multiples (K is a constant) as initial conditions and outputting a base scrambling code in response to a load command from a controller;
the controller for, upon request of initialization for scrambling code generation, ommanding the storage to load a base scrambling code having the highest index substantially equal to or lower than the index of an intended scrambling code to be generated and commanding a scrambling code generator to cyclically shift as many times as the difference between the indexes of the base scrambling code and the intended scrambling code; and
the scrambling code generator for generating the intended scrambling code by cyclically shifting the base scrambling code under the control of the controller.

14. The apparatus of claim 13, wherein the initialization for generating the scrambling code is carried out at each frame boundary.

15. The apparatus of claim 14, wherein the storage stores the generated scrambling code for use in a next initialization.

16. The apparatus of claim 13, wherein the scrambling code is generated at a time point having a specific offset from a frame boundary.

17. A method of generating a scrambling code through initialization in a CDMA mobile communication system where first M successive base scrambling codes and masks with offsets being M multiples are stored as initial conditions, the method comprising the steps of:
loading a base scrambling code having an index being the modulo M of the index of an intended scrambling code to be generated;
loading a mask having the highest offset substantially equal to or lower than the index of the intended scrambling code; and
generating the intended scrambling code by masking the base scrambling code with the loaded mask.

18. The method of claim 17, wherein the initialization for generating the scrambling code is carried out at each frame boundary.

19. The method of claim 17, wherein the scrambling code is generated at a time point having a specific offset from a frame boundary.

20. An apparatus for generating a scrambling code through initialization in a CDMA mobile communication system, comprising:
a storage for storing first M successive base scrambling codes and masks with offsets being M multiples are stored as initial conditions and outputting one of the base scrambling codes in response to a load command from a controller;
the controller for, upon request of initialization for scrambling code generation, commanding the storage to load a base scrambling code having an index being the modulo M of the index of an intended scrambling code to be generated and a mask having the highest offset substantially equal to or lower than the index of the intended scrambling code; and
a scrambling code generator for generating the intended scrambling code by masking the base scrambling code with the loaded mask.

21. The apparatus of claim 20, wherein the initialization for generating the scrambling code is carried out at each frame boundary.

22. The apparatus of claim 20, wherein the scrambling code is generated at a time point having a specific offset from a frame boundary.

23. A method of generating a scrambling code through initialization in a CDMA mobile communication system where L base scrambling codes having indexes being N multiples (N is a constant) and masks with offsets being M multiples (M=NxL) are stored as initial conditions, the method comprising the steps of:
loading a base scrambling code having an index substantially equal to or lower than the modulo M of the index of an intended scrambling code to be generated;
cyclically shifting the base scrambling code as many times as the difference between the index of the base scrambling code and the modulo M of the index of the intended scambling code to generate the intended scrambling code;
loading a mask having the highest offset substantially equal to or lower than the index of the intended scrambling code; and
generating the intended scrambling code by masking the shifted base scrambling code with the loaded mask.

24. The method of claim 23, wherein the initialization for generating the scrambling code is carried out at each frame boundary.

25. The method of claim 24, further comprising the step of storing the generated scrambling code for use in a next initialization.

26. The method of claim 23, wherein the scrambling code is generated at a time point having a specific offset from a frame boundary.

27. An apparatus for generating a scrambling code through initialization in a CDMA mobile communication system, comprising:
a storage for storing L base scrambling codes having indexes being N multiples (N is a constant) and masks with offsets being M multiples (M=N×L) as initial conditions and outputting one of the base scrambling codes and one of the masks in response to a load command from a controller;
the controller for, upon request of initialization for scrambling code generation, commanding the storage to load a base scrambling code having an index substantially equal to or lower than the modulo M of the index of an intended scrambling code to be generated and a mask having the highest offset substantially equal to or lower than the index of the intended scrambling code, and commanding a scrambling code generator to cyclically shift the base scrambling code as many times as the difference between the index of the base scrambling code and the modulo M of the index of the intended scrambling code to generate the intended scrambling code; and
the scrambling code generator for generating the intended scrambling code by cyclically shifting the base scrambling code as many times as the difference between the index of the base scrambling code and the modulo M of the index of the intended scrambling code and masking the shifted base scrambling code with the loaded mask.

28. The apparatus of claim 27, wherein the initialization for generating the scrambling code is carried out at each frame boundary.

29. The apparatus of claim 27, wherein the storage stores the generated scrambling code for use in a next initialization.

30. The apparatus of claim 27, wherein the scrambling code is generated at a time point having a specific offset from a frame boundary.
